(19) United States
(12) Patent Application Publication
(10) Pub. No.: US 2007/0132363 A1
(43) Pub. Date: Jun. 14, 2007

(54) Light source for projection system

(75) Inventors: Wei-Chih Lin, Chu-Tung (TW); Shih-Pu Chen, Chu-Tung (TW); Jung-Yu Li, Chu-Tung (TW); Yi-Ping Lin, Chu-Tung (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/417,048

(22) Filed: May 4, 2006

(30) Foreign Application Priority Data
Dec. 9, 2005 (TW) 94143481

(51) Int. Cl. H01J 63/04; H01J 1/62

(52) U.S. Cl. 313/496

(57) ABSTRACT

A light source for projection system is installed on a projector and employs the field emission property between a cathode and an anode to stimulate a fluorescent powder layer for the same to emit light. The projection light source has sufficient brightness without the problems of producing high amount of heat and short service life. The high brightness of the light source enhances the quality of images projected by the projector and largely increases the economic effects of the projector.

### FIELD OF THE INVENTION

The present invention relates to a light emitting source, and more particularly to a light source for projection system that employs a field emission illumination structure.

### BACKGROUND OF THE INVENTION

The currently available projectors mainly employ three different types of display techniques, namely, the cathode ray tube (CRT) projection technique, the liquid crystal display (LCD) projection technique, and the recently rapidly developed digital light processor (DLP) projection technique. While the CRT projector has the advantages of displaying rich color images, good color reproduction, and excellent geometric distortion adjusting ability, it has the drawbacks of low brightness of projected images, complicate operating procedures, big volume, strict installation environment requirements, and high selling price. Therefore, the CRT projectors are rarely seen in the market now. The LCD projector has the advantages of good color reproduction, high resolution, small volume, low weight, and easy to carry and operate, and has gradually taken the place of the CRT projector and becomes a major product in the projector market. The DLP projector employs a reflective projection technique, and has become a very hot and highly potential product in the market due to the advantages of providing high definition and stable images, good light reflection efficiency, high contrast, and uniform brightness.

Optical engine and light source are two important factors that have great influences on the high definition of image projected by the projector. In the past time, the optical engine is the focus being constantly researched and developed in the field of projectors. The lamp used in the projector belongs to a consumptive material, and therefore requires special care in the after service and maintenance of the projector.

However, there is not significant development in the light source for projector up to now. Currently, the metal halide lamp is widely used as a light source for the front projector. When the metal halide lamp is in a lightened state, the voltage at two ends of the lamp is about 60˜80 volts (V), the gas pressure in the lamp is larger than 10 kgs/cm, and the temperature of the lamp is normally higher than 1000° C. with the filament of the lamp almost in a half-molten state. Under these circumstances, there are many limits in using the projector. For instance, it is absolutely forbidden to vibrate or move the projector when the same is in use, so as to protect the lamp of the projector against breaking. Moreover, due to the high amount of heat generated by the lamp during operation thereof, the projector must be provided with a good heat radiating system. The projector using the conventional metal halide lamp as the light source thereof is not suitable for continuous use over a prolonged time, and should not be switched off until the lamp is fully cooled. The metal halide lamp has very short half life, and tends to become half as bright as before when the lamp has been used over 1000 hours.

### SUMMARY OF THE INVENTION

A primary object of the present invention is to provide a light source for projection system that employs a field emission illumination structure to take the place of other existing light sources for projection systems, so as to overcome the problems existed in the conventional projection light sources, including insufficient brightness, high amount of heat generated during operation of the projection system, and considerably short usable life.

To achieve the above and other objects, the light source for projection system according to the present invention includes a transparent housing, an anode and a cathode provided in the housing without contacting with each other, and a fluorescent powder layer coated on the anode. Due to a high electric field between the cathode and the anode, electrons at the cathode escape from the cathode to impact the fluorescent powder layer, stimulating the latter to emit light.

In an embodiment of the present invention, the anode is in the shape of a cup, and the cathode is provided in the cap-shaped anode without contacting with the anode. The fluorescent powder layer is coated on an inner surface of the cup-shaped anode. The electric field between the cathode and the anode drives the cathodic electrons to stimulate the fluorescent powder layer to emit light.

With the projection light source employing the field emission illumination structure, light of sufficient brightness is emitted without producing high amount of heat to thereby largely extend the service life of the projector lamp. Moreover, image projected by the projector using the light source structure of the present invention has high resolution and brightness to greatly upgrade the economic effects of the projector.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a conceptual view showing the integration and application of a projection light source of the present invention on a projector;

FIG. 2 schematically shows a light source for projection system according to a first embodiment of the present invention;

FIG. 3 schematically shows a light source for projection system according to a second embodiment of the present invention; and

FIG. 4 schematically shows a variant of the light source for projection system according to the second embodiment of the present invention.

### DETAILED DESCRIPTION OF THE PREFERRED EMBODIMENTS

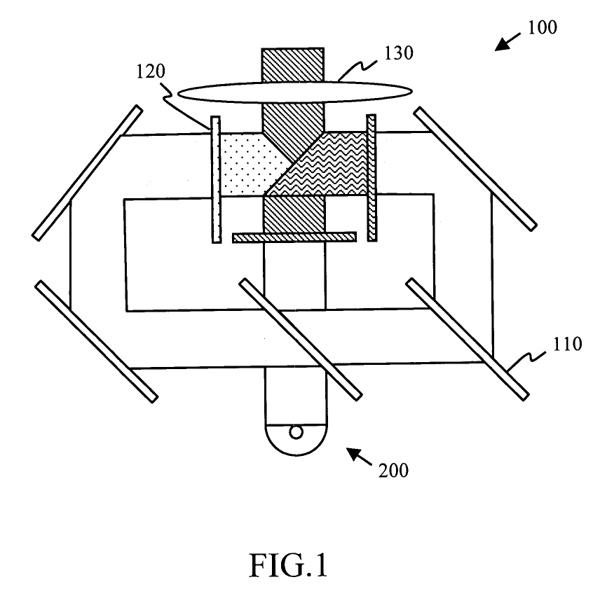

Please refer to FIG. 1 that schematically shows a light source for projection system 200 according to the present invention being integrated on a projector 100.

For the purpose of simplicity, the present invention is also briefly referred to as the projection light source throughout the specification and the appended claims. The projection light source 200 adopts a field emission illumination structure. Light produced by the projection light source 200 is separated by multiple beam splitters 110 in the projector 100 into three primary color lights of red (R), green (G), and blue (B). The three primary color lights RGB separately pass through three LCD panels 120, and optical signals of the three colors RGB are combined by an X-prism 130 into an image to be projected and magnified on a screen via projection lenses.

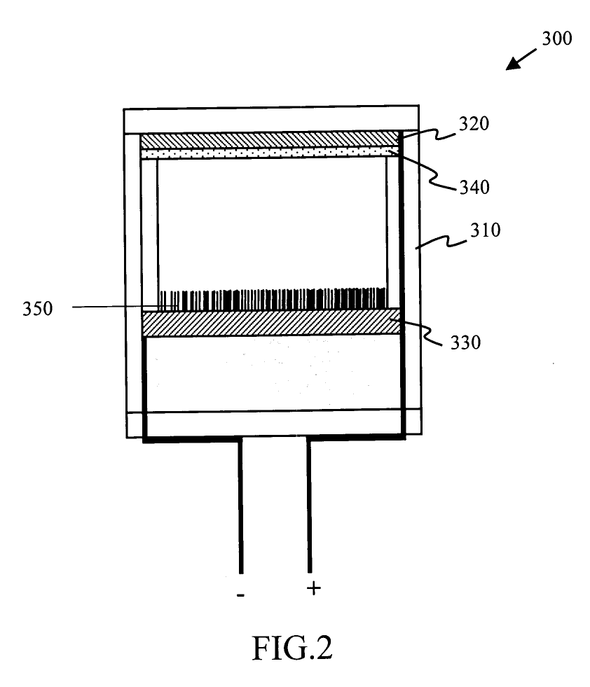

FIG. 2 schematically shows a projection light source 300 according to a first embodiment of the present invention. The projection light source 300 includes a transparent housing 310, an anode 320, a cathode 330, a fluorescent powder layer 340, and a field emission element 350. The anode 320, the cathode 330, the fluorescent powder layer 340, and the field emission element 350 are provided in the transparent housing 310, and the anode 320 and the cathode 330 are located at two opposite sides of the transparent housing 310 without contacting with each other. A carbon nano material or a spindle structure is grown on the cathode 330 to serve as an emitter. The anode 320 consists of a conductive metal, such as aluminum, that is reflective to enable an increased reflectivity as well as enhanced brightness and luminescence efficiency. The fluorescent powder layer 340 is coated on the anode 320. Due to a high electric field between the cathode 330 and the anode 320, electrons escape from the cathode 330 to impact the fluorescent powder layer 340 on the anode 320, causing the fluorescent powder layer 340 to emit light. The field emission element 350 may be a carbon nano material, a conductive metal oxide, a metal micro-structure, or a spindle array.

In the first embodiment of the present invention, the projection light source 300 is in the form of a long lamp tube. However, it is understood the projection light source of the present invention may have a housing being differently shaped according to actual need.

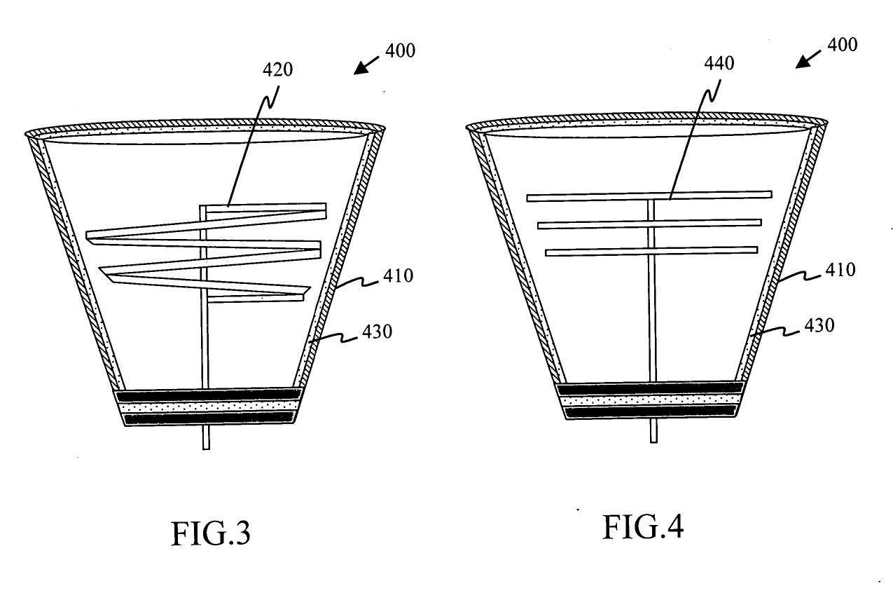

FIG. 3 schematically shows a projection light source 400 according to a second embodiment of the present invention. The projection light source 400 includes an anode 40, a cathode 420, and a fluorescent powder layer 430. The anode 410 consists of a conductive metal, and is in the form of a cup. The cathode 420 is in the form of a coil and located in the cup-shaped anode 410 without contacting with the anode 410. The fluorescent powder layer 430 is coated on an inner surface of the cup-shaped anode 410. An electric field between the cathode 420 and the anode 410 drives electrons to escape from the cathode 420 and stimulate the fluorescent powder layer 430 to emit light.

The shape of a cathode electrode is very important in a field emission illumination structure. With an improperly shaped electrode, the phenomenon of electric arc and concentrated discharge tends to occur in a high voltage field emission. Thus, the coiled cathode 420 in the second embodiment of the present invention may be changed to other shapes depending on actual application thereof.

FIG. 4 schematically shows a variant of the second embodiment of FIG. 3 having a cathode 440 in the form of multiple discs.

In the present invention, the cathode or the anode is made of a carbon nano material to produce high electric field and stimulate field emission electrons to obtain low turn on field and low operating voltage. Alternatively, the cathode or the anode may be made of other materials capable of enhancing the field emission property, such as oxides, metal structures, nitrides, or arrayed spindles, to achieve the same good effect. Wherein, the carbon nano material may be selected from the group consisting of carbon nanotubes, carbon nanowalls, and diamond-like films (i.e. diamond-like carbon). Zinc oxide (ZnO) is one of the oxides capable of enhancing the field emission property. Aluminum (Al), Molybdenum (Mo), tungsten (W), or silicon (Si) may be selected as the metal structure to enhance the field emission property. And, gallium nitride (GaN) or baron nitride (BN) may be selected as the nitride to enhance the field emission property.

The fluorescent powder layer may include red, green, or blue fluorescent powder. The light emitted by the fluorescent powder layer depends on the types of fluorescent powder included in the layer. The fluorescent powder of different colors may be differently arrayed according to desired applications, such as lighting fixtures or displays, so as to produce a linear or a plane light source.

Briefly speaking, the projection light source of the present invention utilizes the field emission property of the cathode and the anode to stimulate the fluorescent powder layer to emit light. The light so emitted has high brightness to enhance the quality of images projected by the projector, giving the projected images rich colors and reduced geometric distortion. Moreover, the projection light source of the present invention produces low heat and accordingly does not require a heat radiating system with high radiating efficiency. The projector with the projection light source of the present invention may be directly switched off before the light source is fully cooled. The projection light source with the field emission illumination structure has long service life and long half-life period, is not subject to strict installation environment requirements and vibration problem, and has small volume, and is therefore very practical for use.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A light source for projection system for used on a projector, comprising:
a transparent housing;
an anode provided in said transparent housing;
a cathode provided in said transparent housing without contacting with said anode; and
a fluorescent powder layer coated on said anode;
whereby electrons at said cathode are driven by an electric field between said cathode and said anode to stimulate said fluorescent powder layer to emit light.

2. The light source for projection system as claimed in claim 1, wherein said fluorescent powder layer includes fluorescent powder of different colors.

3. The light source for projection system as claimed in claim 2, wherein said fluorescent powder layer includes fluorescent powder of red (R), green (G) and blue (B) colors.

4. The light source for projection system as claimed in claim 1, wherein said cathode is made of a material selected from the group consisting of carbon nano material, conductive oxide, metal structure, nitride, and arrayed spindles.

5. The light source for projection system as claimed in claim 4, wherein said carbon nano material is selected from the group consisting of carbon nanotube, carbon nanowall, and diamond-like carbon.

6. The light source for projection system as claimed in claim 4, wherein said oxide is zinc oxide (ZnO).

7. The light source for projection system as claimed in claim 4, wherein said metal structure is selected from the group consisting of aluminum (Al), molybdenum (Mo), tungsten (W), and silicon (Si).

8. The light source for projection system as claimed in claim 4, wherein said nitride is selected from the group consisting of gallium nitride (GaN) and baron nitride (BN).

9. The light source for projection system as claimed in claim 1, wherein said anode is made of a material selected from the group consisting of carbon nano material, conducting oxide, metal structure, nitride, and arrayed spindles.

10. The light source for projection system as claimed in claim 9, wherein said carbon nano material is selected from the group consisting of carbon nanotube, carbon nanowall, and diamond-like carbon.

11. The light source for projection system as claimed in claim 9, wherein said oxide is zinc oxide (ZnO).

12. The light source for projection system as claimed in claim 9, wherein said metal structure is selected from the group consisting of aluminum (Al), molybdenum (Mo), tungsten (W), and silicon (Si).

13. The light source for projection system as claimed in claim 9, wherein said nitride is selected from the group consisting of gallium nitride (GaN) and baron nitride (BN).

14. A light source for projection system, comprising:
A cup-shaped anode;
a cathode provided in said cup-shaped anode without contacting with said anode; and
a fluorescent powder layer provided on an inner surface of said cup-shaped anode;
whereby electrons at said cathode are driven by an electric field between said cathode and said anode to stimulate said fluorescent powder layer to emit light.

15. The light source for projection system as claimed in claim 14, wherein said cathode is in the form of multiple discs.

16. The light source for projection system as claimed in claim 14, wherein said cathode is in the form of a coil.

17. The light source for projection system as claimed in claim 14, wherein said fluorescent powder layer includes fluorescent powder of different colors.

18. The light source for projection system as claimed in claim 17, wherein said fluorescent powder layer includes fluorescent powder of red (R), green (G), and blue (B) colors.

19. The light source for projection system as claimed in claim 14, wherein said cathode is made of a material selected from the group consisting of carbon nano material, conductive oxide, metal structure, nitride, and arrayed spindles.

20. The light source for projection system as claimed in claim 19, wherein said carbon nano material is selected from the group consisting of carbon nanotube, carbon nanowall, and diamond-like carbon.

21. The light source for projection system as claimed in claim 19, wherein said oxide is zinc oxide (ZnO).

22. The light source for projection system as claimed in claim 19, wherein said metal structure is selected from the group consisting of aluminum (Al), molybdenum (Mo), tungsten (W), and silicon (Si).

23. The light source for projection system as claimed in claim 19, wherein said nitride is selected from the group consisting of gallium nitride (GaN) and baron nitride (BN).

24. The light source for projection system as claimed in claim 14, wherein said anode is made of a material selected from the group consisting of carbon nano material, conducting oxide, metal structure, nitride, and arrayed spindles.

25. The light source for projection system as claimed in claim 24, wherein said carbon nano material is selected from the group consisting of carbon nanotube, carbon nanowall, and diamond-like carbon.

26. The light source for projection system as claimed in claim 24, wherein said oxide is zinc oxide (ZnO).

27. The light source for projection system as claimed in claim 24, where in said metal structure is selected from the group consisting of aluminum (Al), molybdenum (Mo), tungsten (W), and silicon (Si).

28. The light source for projection system as claimed in claim 24, wherein said nitride is selected from the group consisting of gallium nitride (GaN) and baron nitride (BN).
